(19) United States
(12) Patent Application Publication
(10) Pub. No.: US 2004/0160409 A1
(43) Pub. Date: Aug. 19, 2004

(54) Attribute information management system

(75) Inventors: Toshiya Kojima, Kanagawa (JP); Setsuji Tatsumi, Kanagawa (JP); Kanji Nagashima, Kanagawa (JP); Seiichiro Oku, Kanagawa (JP); Yoshiro Yamazaki, Kanagawa (JP); Kenichi Kodama, Kanagawa (JP); Seiichi Inoue, Kanagawa (JP); Naoki Kusunoki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/778,302

(22) Filed: Feb. 17, 2004

(30) Foreign Application Priority Data
Feb. 18, 2003 (JP) 2003-39743

(51) Int. Cl. G09G 3/34; B41J 2/41; G02B 26/00

(52) U.S. Cl. 345/107; 347/112; 359/296

(57) ABSTRACT

At a host device, attribute information (the presence or absence of an overwriting prohibition and the like) of each of image display mediums (electronic papers) is stored in association with individual identification numbers, which are unique to each image display medium. Hence, when a predetermined image is to be displayed at an image display medium in accordance with input from an operation portion, for example, an image display medium for which an overwriting prohibition has not been written to the attribute information can be selected, and image data can be transmitted to this display medium for displaying the image. Thus, image display at each image display medium can be excellently controlled in accordance with attribute information such as overwriting prohibitions and the like.

### CROSS-REFERENCE TO RELATED APPLICATION

This application claims priority under 35 USC 119 from Japanese Patent Application No. 2003-39743, the disclosures of which are incorporated by reference herein.

### BACKGROUND OF THE INVENTION

1. Field of the Invention

The present invention relates to an attribute information management system for administering attribute information of an image display medium such as electronic paper or the like.

2. Description of the Related Art

In recent years, “electronic paper”, which displays images that are rewritable by electronic signals and which can preserve image display states, has been proposed, and various methods for utilization thereof have been proposed (see, for example, Japanese Patent Application Laid-Open (JP-A) Nos. 2001-92387 and 2002-18362).

For example, given that electronic paper has flexibility similar to paper and/or preserves an image display state even when a power source is in an “off” state, employment in a manner similar to a book or a file binder has been considered.

Further, because electronic paper displays an image when image information and the like is inputted by electronic signals, control of switching between display and non-display on the basis of these electronic signals or the like has been considered. For example, in the aforementioned JP-A No. 2002 -18362, a structure is proposed which utilizes electronic paper in a medium for displaying addresses, makes display of the addresses switchable, and facilitates goods deliveries or the like.

Because electronic paper is capable of switching the images that are displayed, as in the structure of JP-A No. 2002-18362, various images can be displayed. However, in a case in which, for example, a plurality of electronic papers are stacked as layers in a binder-type structure, it may not be clear which pages of the electronic paper are overwritable (rewritable), and for which of the electronic papers overwriting is not permitted. In consequence, images which are supposed to be conserved may be erased by overwriting.

In order to prevent this sort of problem, prohibiting rewriting of images that are displayed at all electronic papers of a binder structure has been considered. However, this negates the advantage of rewritability, which is the greatest benefit of electronic paper.

Moreover, in JP-A No. 2002-18362, although the fact of the images being rewritable is mentioned, limits on the number of rewriting cycles and the like are not mentioned. Specifically, if rewriting of images is carried out repeatedly, persistent electronic fields may arise in the electronic paper, and display conditions of the images may deteriorate. However, in conventional proposals for methods of employing electronic paper, a principle of replacing electronic paper in accordance with a number of rewriting cycles has not been mentioned, and specific structures for counting numbers of rewriting cycles have not been proposed at all.

### SUMMARY OF THE INVENTION

In consideration of the circumstances described above, an object of the present invention is to provide an attribute information management system capable of favorably controlling image display of an image display medium.

In a first aspect of the present invention, an attribute information management system for managing attribute information relating to an image display medium includes: the image display medium, which displays an image based on inputted image information; a storage section which stores information of attributes of the image display medium; and a control section which controls image display at the image display medium in accordance with the attribute information.

Operation of the above-described first aspect will be described.

On the basis of the attribute information stored at the storage section, the control section can control whether or not an image is displayed at the image display medium. For example, if information prohibiting overwriting (rewriting) is stored as the attribute information at the storage section, rewriting of the image will not be implemented even if a signal for rewriting (an image) to the image display medium is inputted, and an image display state of the image display medium can be preserved.

In a second aspect of the present invention, in accordance with an input from outside, the control section causes the attribute information to be displayed at the image display medium.

Operation of the above-described second aspect will be described.

When a viewer operates the system from outside (inputs from an external section), the control section displays the attribute information that has been recorded in the storage section at the image display medium. Hence, the viewer can confirm the attribute information on the image display medium. For example, a creator of an image, a creation date and time, the presence or absence of an overwriting prohibition (protection) and the like, and the like can be displayed.

Here, because the attribute information is not displayed at the image display medium unless this is inputted from outside, image display on the image display medium will usually not be hindered by display of the attribute information.

In a third aspect of the present invention, the attribute information stored at the storage section includes a number of cycles of image writing of the image display medium, the number of cycles of image writing being updated each time when image writing to the image display medium is implemented.

Operation of the above-described third aspect will be described.

Usually, when a number of rewriting cycles of an image display medium exceeds a predetermined number, image display conditions are significantly deteriorated due to deterioration of the image display medium. Accordingly, at the time of image rewriting, the number of rewriting cycles, which is stored as attribute information in the storage section, is updated. A deterioration of the image display conditions of the image display medium is detected in accordance with this number of rewriting cycles. A warning for replacement of the image display medium is given before it becomes impossible to excellently display images. Alternatively, counter-measures such as not displaying images or the like can be taken.

In a fourth aspect of the present invention, when the number of cycles of writing has reached a predetermined number, the control section implements a warning that the image display medium is scheduled for replacement.

Operation of the above-described fourth aspect will be described.

The control section warns that the image display medium is scheduled for replacement when the number of rewriting cycles of the image-recording medium reaches the predetermined number. Hence, the image display medium is replaced by a user before it becomes impossible to display images excellently. A structure that warns that a certain unit (component) of the image display medium is scheduled for replacement, rather than the whole of the image display medium, is also possible.

In a fifth aspect of the present invention, the attribute information management system further includes: an authentication section which authenticates a viewing requester, who requests viewing of an image and wants the image to be displayed at the image display medium; and a judgment section which, on the basis of the attribute information stored at the storage section, judges whether or not the viewing requester is a user authorized for viewing of the image. A specified image is displayed at the image display medium if the viewing requester is a user authorized for viewing, and the image display medium does not display the image if the viewing requester is not a user authorized for viewing.

Operation of the above-described fifth aspect will be described.

Identity of the viewing requester is authenticated by the authentication section, and it is determined by the judgment section whether or not the viewing requester is a user authorized to view the image on the basis of the attribute information that is stored in the storage section. As a result, if the viewing requester is a user authorized to view the image, the specified image is displayed at the image display medium, and if the viewing requester is not a user authorized to view the image, the image is not displayed at the image display medium. Thus, users other than users who are authorized to view the image cannot use the image display medium to view the image, which is excellent for security.

### BRIEF DESCRIPTION OF THE DRAWINGS

FIG. 1 is a perspective view showing external appearance of electronic paper relating to an embodiment of the present invention.

FIG. 2 is a view showing a state in which the electronic paper relating to the embodiment of the present invention is stacked in layers.

FIG. 3 is a perspective view showing the electronic paper and a host device, which retains the electronic paper, relating to the embodiment of the present invention.

FIG. 4 is a sectional view showing a state in which the host device relating to the embodiment of the present invention retains one sheet of the electronic paper.

FIG. 5 is a sectional view showing a state in which the host device relating to the embodiment of the present invention retains three sheets of the electronic paper.

FIG. 6 is a block diagram showing electronic structure of the electronic paper and host device relating to the embodiment of the present invention.

FIG. 7 is a flowchart showing processing when communication is carried out at the host device relating to the embodiment of the present invention.

FIG. 8 is a flowchart showing an image update process which is carried out at the host device relating to the embodiment of the present invention.

### DETAILED DESCRIPTION OF THE INVENTION

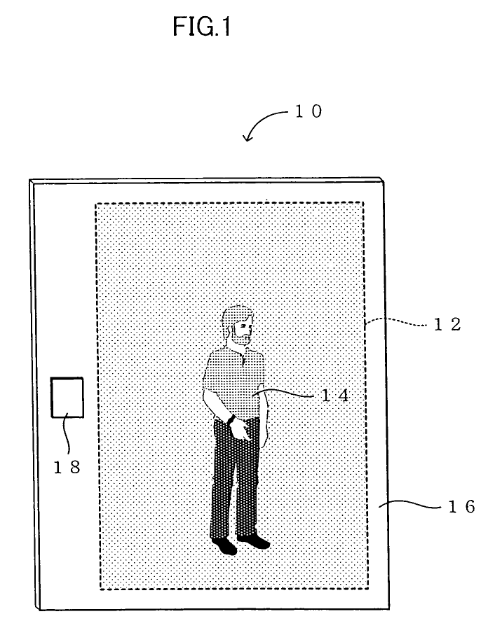

An attribute information management system relating to an embodiment of the present invention will be described with reference to FIGS. 1 to 8.

FIG. 1 shows an external view of an electronic paper 10 relating to the embodiment of the present invention. The electronic paper 10 relating to the present embodiment is a medium for which image information is rewritable, and has a memory characteristic for preserving an image display state even when supply of power from a power source is ended. It is possible to employ electronic papers that employ technologies such as, for example, toner rotation, electrophoresis, thermal rewritability, liquid crystals, electrochromy and the like. Note that the present invention is also applicable to electronic paper without the memory characteristic.

As shown in FIG. 1, the electronic paper 10 includes a display area 12, and acts so as to display an image 14, which may include text images, at the display area 12.

The display area 12 is provided with an outer frame 16, and the display area 12 is retained by the outer frame 16. Here, the display area 12 and the outer frame 16 are structured of materials which are flexible, and can be handled similarly to paper or the like.

The outer frame 16 includes a connection portion 18 for effecting electronic connection when a plurality of the electronic papers 10 are superposed. Image data for display at the display area 12 and the like can be transmitted/received through the connection portion 18.

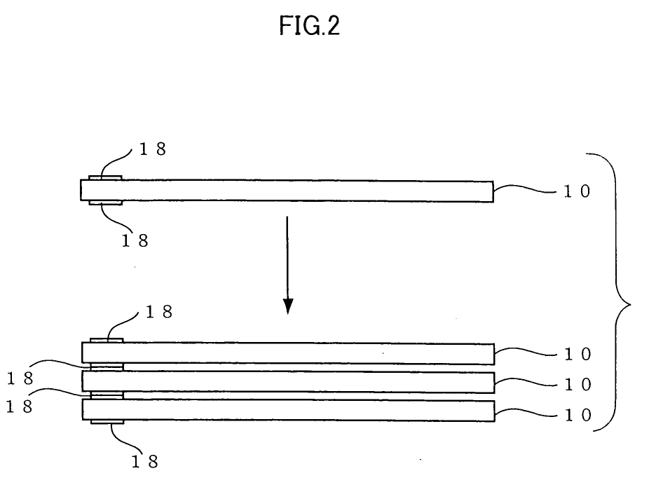

As shown in FIG. 2, the connection portions 18 are provided at front and rear of the electronic papers 10 such that, when the plurality of the electronic papers 10 are superposed, the respective connection portions 18 are connected. The connection portions 18 may employ contact-type structures such as connectors that connect mechanically, contacts or the like. Alternatively, the connection portions 18 may employ non-contact-type structures which utilize weak electromagnetic induction or the like.

The electronic paper 10 is formed with substantially the same form at both front and rear faces thereof, and the front and rear can be assigned as appropriate.

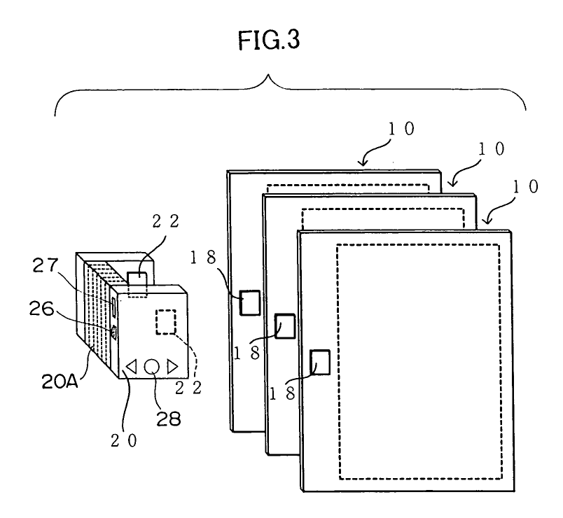

As shown in FIG. 3, the electronic papers 10 can be retained in the form of a binder by a host device 20. At the host device 20, a pair of connection portions 22 is provided for communicating with the connection portions 18 of the electronic papers 10. The connection portions 22 are provided at positions corresponding to the connection portions 18 of the electronic papers 10. The host device 20 is structured such that image data which has been accumulated at the host device 20 is transmitted to the electronic papers 10 and such that image data can be received from the electronic papers 10.

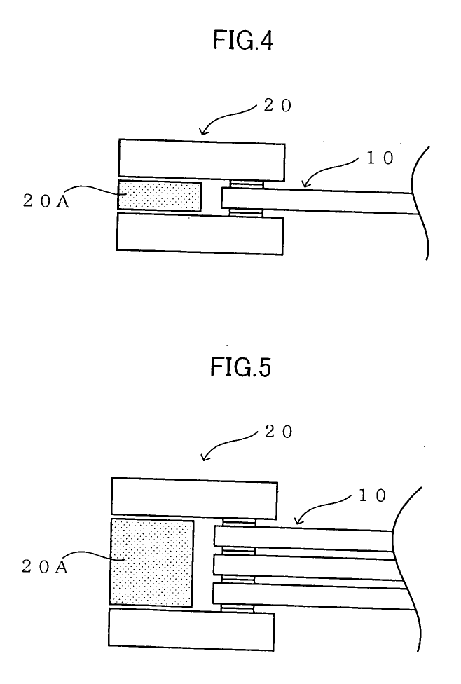

As shown in FIGS. 4 and 5, the host device 20 includes an extensible portion 20A, which extends and contracts in accordance with a number of the electronic papers 10 to be retained. The extensible portion 20A extends in units corresponding to increases in the number of the electronic papers 10 to be retained. FIG. 4 shows an example in which the host device 20 retains one of the electronic paper 10, and FIG. 5 shows an example in which the host device 20 retains three of the electronic papers 10.

Further, as shown in FIG. 3, an external input portion 26, a card slot 27, and an operation section 28 are provided at side faces of the host device 20. The external input portion 26 is for inputting image data from an external section. An ID card, which is a proof of identity of a viewer, is inserted at the card slot 27. The operation section 28 is structured by buttons, touch panels or the like, for implementing writing of attribute information and the like (for example, an image overwriting prohibition) from the external section, which is described later.

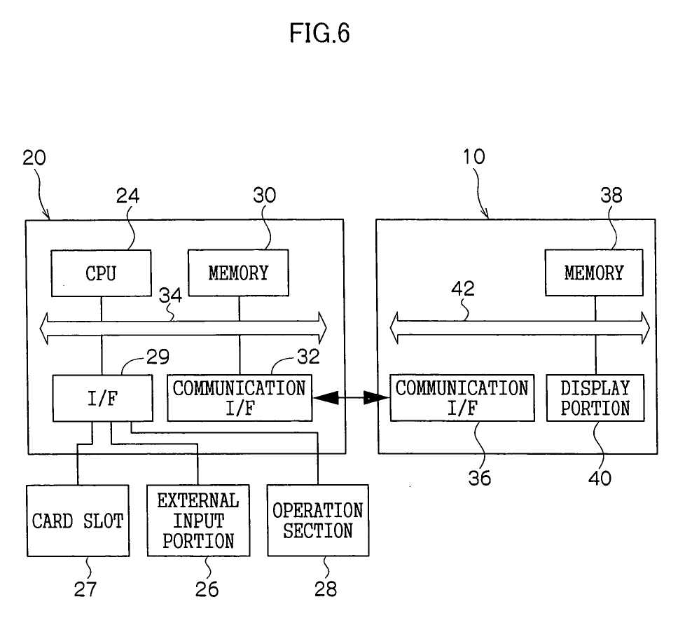

Next, electrical structure of the electronic paper 10 and the host device 20 will be described with reference to FIG. 6.

The host device 20 is equipped with a CPU 24, an interface (I/F) 29, a memory 30, a communication interface (communication I/F) 32, and a bus 34 which connects these. The I/F 29 is connected to the external input portion 26, the card slot 27 and the operation section 28. The host device 20 as a whole is controlled by the CPU 24.

The external input portion 26 is a structure which inputs image data for displaying at the electronic paper 10 from a personal computer or other external device. The image data that is inputted by the external input portion 26 is stored at the memory 30. Image data that has accumulated at the memory 30 is converted to data of a predetermined format by the CPU 24, and is outputted through the communication I/F 32 and the connection portions 22 to the electronic paper 10.

The host device 20 enables the viewer to carry out various operations from the operation section 28. For example, instructions for displaying the image data stored in the memory 30, attribute data, which is discussed later, and the like at the electronic paper 10 are enabled by operation of the operation section 28.

Further, attribute information relating to each electronic paper 10 is saved at the memory 30. Specifically, a number of cycles of image writing, the date and time of the most recent time of writing, the presence or absence of an overwriting prohibition, writing history, the creator and creation date and time of a written image, users (ID numbers) authorized for viewing, size of an image and the like are stored in association with an individual identification number of each electronic paper 10.

The electronic paper 10 is structured to include a communication I/F 36, a memory 38, a display portion 40, and a bus 42 which connects these. The image data, which has been transmitted by the communication I/F 32 of the host device 20, b is inputted to the electronic paper 10 through the connection portion 18 and the communication I/F 36.

The image data which has been inputted through the communication I/F 36 is inputted to the display portion 40 via the bus 42, and an image is displayed at the display area 12 by the display portion 40.

Further, image data that remains when image data that is to be displayed at the display area 12 has been extracted by the communication I/F 36 is transmitted through the communication I/F 36 and the connection portion 18 to another of the electronic papers 10.

The memory 38 is structured by a non-volatile memory (for example, an EEPROM), and stores an individual identification number which is unique for each electronic paper. Further, a display state of the image that is displayed at the display portion 40 is preserved even in a state in which electric power is not supplied.

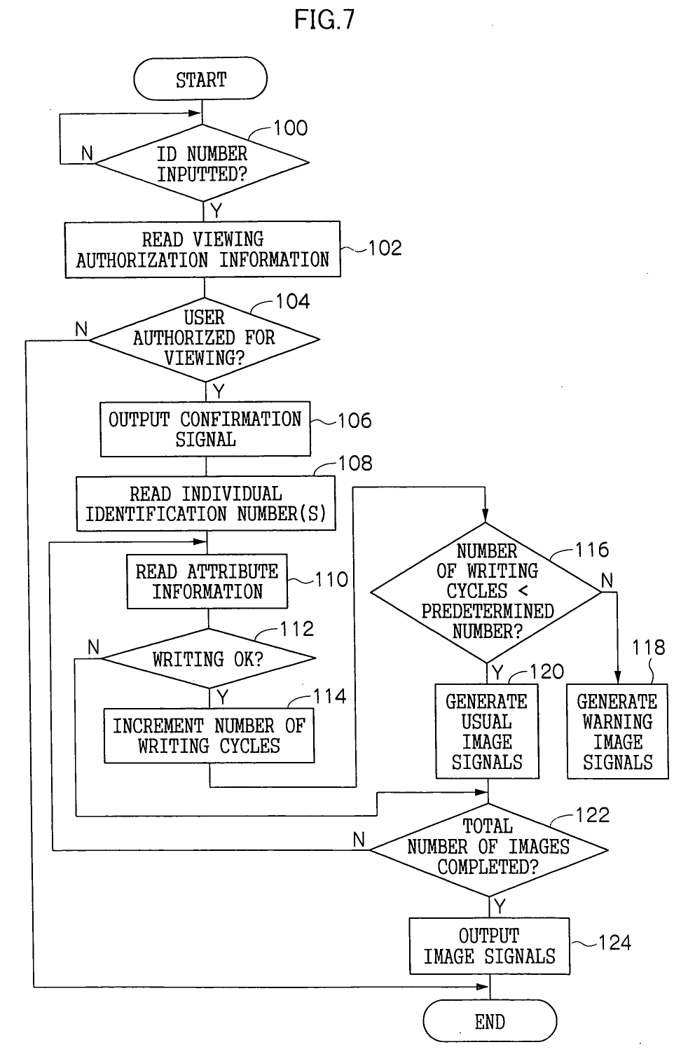

Next, an image display process which employs the attribute information management system structured by the host device 20 and the electronic paper 10, which are structured as described above, will be described with reference to the flowchart of FIG. 7.

When a viewer is to make the electronic paper 10 display an image, the viewer inserts an ID card in the card slot 27 of the host device 20, and performs an operation requesting image display at the operation section 28. At this time, if the image data whose display is requested has not already been stored at the memory 30, the image data is inputted from the external input portion 26 and stored in the memory 30.

In the host device 20, when a power source is connected, it is judged whether or not ID number information has been inputted through the I/F 29 to the CPU 24 (step 100). If ID number information has been inputted by insertion of an ID card (“Y” in step 100), information on users authorized for viewing (ID numbers), which has been saved at the memory 30, is read out and it is judged, by matching the ID numbers, whether or not the user inserting the ID card (the viewer) is a user authorized for viewing (steps 102 and 104).

If the viewer is not a user authorized for viewing (“N” in step 104), the process ends without implementing image display processing, and the image is not available for viewing.

If the viewer is a user authorized for viewing (“Y” in step 104), a confirmation signal, for confirming what electronic papers are connected in the binder form, is generated and transmitted through the communication I/F 32 to the electronic papers 10 (step 106).

When this confirmation signal is inputted at the electronic paper 10 through the communication I/F 36, the individual identification number of the electronic paper is read out from the memory 38 and transmitted through the communication I/F 36 to the host device 20. When this individual identification number is inputted at the host device 20, it is confirmed which electronic papers are connected (bound) in the binder (step 108).

Attribute information relating to the individual identification number of this confirmed electronic paper is read from the memory 30 (step 110). This is, for example, overwriting prohibition information, a number of writing cycles and the like relating to this electronic paper.

Next, the CPU 24 judges whether or not writing to the electronic paper is permitted, on the basis of the attribute information of the electronic paper that has been read out (step 112). Specifically, it is judged whether or not information of an overwriting prohibition or the like is included in the attribute information that has been read out. Such a judgement is made because, in a case in which overwriting prohibition information has been written to the attribute information of this electronic paper, a new image cannot be displayed at this electronic paper.

Accordingly, in a case in which writing to the electronic paper is unavailable (“N” in step 112), processing for generating image signals for this electronic paper, as described below, is not carried out.

On the other hand, in a case in which writing to the electronic paper is available, (“Y” in step 112), the number of writing cycles in the attribute information relating to this electronic paper is incremented (step 114).

It is then judged whether or not the incremented number of writing cycles is less than a prescribed number (step 116).

If the number of writing cycles is equal to or greater than the prescribed number (“N” in step 116), warning image data is read from the memory 30, the individual identification number of the electronic paper at which this image is to be displayed is attached to the warning image data, and warning image signals are generated therefrom (step 118). This warning image data is data for an image which prompts the viewer to replace the electronic paper, whose image display capability has deteriorated, instead of the image data whose display is sought by the viewer.

Such warning image signals as described above are presented because the image display capability of the electronic paper deteriorates in accordance with an increase in the number of writing cycles, and when the number of writing cycles reaches the prescribed value, a predetermined image display capability cannot be assured. In such a case, replacement of the corresponding electronic paper needs to be prompted.

On the other hand, if the number of writing cycles is less than the prescribed number (“Y” in step 116), the individual identification number of the electronic paper at which the image is to be displayed is attached to the image data that the viewer has selected, and usual image signals are generated therefrom (step 120). These are image signals in which the individual identification number of the electronic paper is attached to image data corresponding to one sheet of the electronic paper.

Now, in a case in which the viewer has inputted an instruction for display of attribute information from the operation section 28, usual image signals for displaying the attribute data overlaid on the image data are generated and transmitted. Here, this attribute data is expected to be, for example, the creator and creation date of the image data, the presence or absence of an overwriting prohibition, and the like.

Next, it is confirmed that usual image signals have been generated for a number of electronic papers corresponding to a number of images indicated by the viewer (step 122). The generation of image signals is repeated until usual image signals have been generated for the total number of images (“N” in step 122, and steps 110 to 120).

Hence, when the usual image signals have been generated for the total number of images, the usual image signals and/or warning image signals are outputted through the communication I/F 32 to the electronic papers 10 (step 124).

At the electronic papers 10 set in the binder form, of the above-described image signals, only image signals to which the corresponding individual identification number has been attached are inputted from the communication I/F 36. At each electronic paper 10 to which usual image signals have been inputted, the image is displayed at the display area 12 by the display portion 40. In cases with an attribute information display instruction, attribute information is displayed at an end portion of the displayed image.

Further, at each electronic paper 10 to which the warning image signals have been inputted, the warning image is displayed at the display area 12 of the electronic paper 10 by the display portion 40. Examples of the warning image include an image displaying a warning that says “Please replace this electronic paper.”

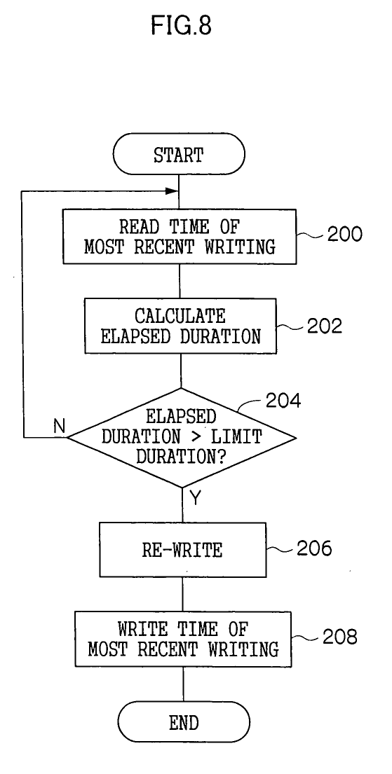

Further, deterioration of an image display state of the electronic paper is prevented by the following control. Specifically, as shown in FIG. 8, at the host device 20, at certain time intervals the most recent time of writing is read from the attribute information relating to each electronic paper 10 at which images are displayed, which attribute information being stored in the memory 30, and a duration that has elapsed from the most recent time of writing until the current time of reading is calculated (steps 200 and 202). Then, it is judged whether the calculated elapsed duration has exceeded a limit duration (it is assumed that the image display state of the electronic paper 10 has been deteriorated if the calculated elapsed duration has exceeded the limit duration) (step 204).

Here, if the elapsed duration has not exceeded the limit duration, (“N” in step 204), the image display state of the electronic paper 10 is assumed to be good, and the processing of steps 200 and 202 will be carried out again after a certain period of waiting.

On the other hand, if the elapsed duration has exceeded the limit duration (“Y” in step 204), the image information that has been written to the corresponding electronic paper 10 is again read from the memory 30, attribute information such as the individual identification number and the like of the corresponding electronic paper is attached thereto, and the resulting image information is transmitted to the electronic paper 10 (step 206). As a result, the same image is again displayed at the electronic paper 10 on the basis of the newly transmitted image information. By freshly renewing display of images based on the image information in this manner, excellent display can be continued.

When re-writing is carried out in this manner, the most recent time of writing, in the attribute information relating to the corresponding electronic paper which is stored in the memory 30, is updated (step 208). Thus, image update processing is carried out continuously at fixed intervals.

Accordingly, the attribute information management system structured by the host device 20 and the electronic paper 10 associates the individual identification numbers with the attribute information relating to each electronic paper and individually manages the same. Therefore, individual control of image displays of the respective electronic papers 10 is possible. In particular, because the individual identification number is assigned to the electronic paper 10 and the individual identification number is saved at the memory 38 of the electronic paper 10, it is possible to manage the attribute information of the corresponding electronic paper from the memory 30 of the host device 20.

Specifically, in order to, for example, protect an image which is displayed at one of the electronic papers 10, overwriting of another image at this electronic paper 10 can be prevented by implementing writing of an overwriting prohibition to the attribute information stored in the memory 30 of the host device 20.

Further, it is possible for attribute information saved at the memory 30 to be displayed at the display area 12 of the electronic paper 10 by a viewer instructing attribute information display from the operation section 28. In other words, as required, information such as the creator and creation date of an image, the presence or absence of an overwriting prohibition and the like can be ascertained on the electronic paper.

There is a possibility that the display capability of the electronic paper 10 will deteriorate and that images cannot be displayed excellently when the number of writing cycles exceeds the predetermined number. However, in the present embodiment, the number of writing cycles to each electronic paper is managed as attribute information. Consequently, when the number of writing cycles equals or exceeds the prescribed number, rather than an image being displayed, a warning image is displayed. That is, the viewer can replace the electronic paper when the viewer ascertains the warning image on the electronic paper. Thus, situations in which an image is displayed at electronic paper whose image display capability has deteriorated and in which favorable viewing is not possible can be avoided.

Further again, because it is confirmed by use of the ID number whether or not a viewer is a user authorized for viewing of the electronic paper 10, security characteristics are excellent. For example, a structure is possible in which persons other than authorized personnel cannot display and view restricted images, which are saved inside the memory 30, at the electronic paper 10 by operation of the operation section 28.

The present embodiment is a structure which saves attribute information at the memory 30 of the host device 20 for management thereof. However, a structure which carries out management at the memory 38 of the electronic paper 10 can also be employed. Such a case has the advantage that it is possible to accurately count the number of writing cycles and the like in cases in which the electronic paper 10 is employed at different devices.

Further yet, in the present embodiment, the electronic paper 10 and the host device 20 are connected by the connection portions 18 and 22. However, remote connection portions could also be employed. Specifically, a similar structure which is capable of transmission and reception by wireless communication or the like is possible.

Furthermore, in the present embodiment, the fact or warning that the electronic paper 10 is to be replaced is displayed as an image at the electronic paper 10. However, warning means need not be limited thus, as long as this fact can be ascertained by a viewer or the like.

Furthermore again, in the present embodiment, identification of the viewer is implemented by an ID number of an ID card. However, the present invention is not limited thus. Specifically, a technique that utilizes, for example, fingerprints, voice prints or the like may be used, as long as the technique is capable of identifying the individual.

As described above, according to the attribute information management system of the present invention, image display effected at an image display medium can be excellently controlled in accordance with attribute information.

What is claimed is:

1. An attribute information management system for managing attribute information relating to an image display medium, the system comprising:
the image display medium, which displays an image based on inputted image information;
a storage section which stores information of attributes of the image display medium; and
a control section which controls image display at the image display medium in accordance with the attribute information.

2. The attribute information management system of claim 1, wherein, in accordance with an input from outside, the control section causes the attribute information to be displayed at the image display medium.

3. The attribute information management system of claim 1, wherein the attribute information stored at the storage section includes a number of cycles of image writing of the image display medium, the number of cycles of image writing being updated each time when image writing to the image display medium is implemented.

4. The attribute information management system of claim 3, wherein, when the number of cycles of writing has reached a predetermined number, the control section implements a warning that the image display medium is scheduled for replacement.

5. The attribute information management system of claim 1, further comprising:
an authentication section which authenticates a viewing requester, who requests viewing of an image and wants image to be displayed at the image display medium; and
a judgment section which, on the basis of the attribute information stored at the storage section, judges whether or not the viewing requester is a user authorized for viewing of the image,
wherein a specified image is displayed at the image display medium if the viewing requester is a user authorized for viewing, and the image display medium does not display the image if the viewing requester is not a user authorized for viewing.

6. The attribute information management system of claim 1, wherein the attribute information includes information relating to prohibition of overwriting at the image display medium, and the control section may, on the basis of the information relating to prohibition of overwriting, reject display of a new image at the image display medium.

7. The attribute information management system of claim 1, wherein the attribute information includes the inputted image information and a date and time at which an image based on the image information was most recently written at the image display medium.

8. The attribute information management system of claim 7, wherein the control section checks whether or not an image display duration, which is calculated on the basis of the date and time at which the image was most recently written, has exceeded a predetermined limit duration, and if the image display duration has exceeded the limit duration, the control section reads out the image information from the storage section and renews display of the image at the image display medium on the basis of the image information that is read.

9. The attribute information management system of claim 1, wherein the image display medium comprises a memory at which an individual identification number unique to the image display medium is stored.

10. The attribute information management system of claim 9, wherein the storage section stores the attribute information of the image display medium in association with the individual identification number.

11. The attribute information management system of claim 10, wherein the control section reads out the individual identification number from the memory for identifying the image display medium, reads the attribute information corresponding to this individual identification number from the storage section, and controls image display at the image display medium in accordance with this attribute information.

12. The attribute information management system of claim 10, wherein the attribute information includes a number of cycles of image writing, a date and time of the most recent writing, presence or absence of an overwriting prohibition, a writing history, a creator of a written image, a creation date and time of the same, an ID number of a user authorized for viewing, and a size of the image.

13. An attribute information management system for managing attribute information relating to an image display medium, the system comprising:
at least one image display medium which displays an image based on inputted image information, the image display medium including a memory at which an individual identification number unique to the image display medium is stored;
a storage section which stores information of attributes of each image display medium in association with the respective individual identification number; and
a control section which reads out the individual identification number from the memory for identifying the image display medium, reads the attribute information corresponding to this individual identification number from the storage section, and controls image display at the image display medium in accordance with this attribute information.

14. The attribute information management system of claim 13, wherein, in accordance with an input from outside, the control section causes the attribute information to be displayed at the image display medium.

15. The attribute information management system of claim 13, wherein the attribute information stored at the storage section includes a number of cycles of image writing of the image display medium, the number of cycles of image writing being updated each time when image writing to the image display medium is implemented.

16. The attribute information management system of claim 15, wherein, when the number of cycles of writing has reached a predetermined number, the control section implements a warning that the image display medium is scheduled for replacement.

17. The attribute information management system of claim 13, further comprising:
an authentication section which authenticates a viewing requester, who requests viewing of an image by causing image display at the image display medium; and
a judgment section which, on the basis of the attribute information stored at the storage section, judges whether or not the viewing requester is a user authorized for viewing of the image,
wherein a specified image is displayed at the image display medium if the viewing requester is a user authorized for viewing, and the image display medium does not display the image if the viewing requester is not a user authorized for viewing.

18. The attribute information management system of claim 13, wherein the attribute information includes information relating to prohibition of overwriting at the image display medium, and the control section may, on the basis of the information relating to prohibition of overwriting, reject display of a new image at the image display medium.

19. The attribute information management system of claim 13, wherein the attribute information includes the inputted image information and a date and time at which an image based on the image information was most recently written at the image display medium.

20. The attribute information management system of claim 19, wherein the control section checks whether or not an image display duration, which is calculated on the basis of the date and time at which the image was most recently written, has exceeded a predetermined limit duration, and if the image display duration has exceeded the limit duration, the control section reads out the image information from the storage section and renews display of the image at the image display medium on the basis of the image information that is read.

21. The attribute information management system of claim 13, wherein the attribute information includes a number of cycles of image writing, a date and time of the most recent writing, presence or absence of an overwriting prohibition, a writing history, a creator of a written image, a creation date and time of the same, an ID number of a user authorized for viewing, and a size of the image.
